(19) United States
(12) Patent Application Publication
(10) Pub. No.: US 2016/0146420 A1
(43) Pub. Date: May 26, 2016

(54) LIGHT SOURCE MODULE OF LAMP FOR VEHICLE

(71) Applicant: HYUNDAI MOTOR COMPANY, Seoul (KR)

(72) Inventor: Jeong Gyu YANG, Yongin-si (KR)

(21) Appl. No.: 14/671,240

(22) Filed: Mar. 27, 2015

(30) Foreign Application Priority Data
Nov. 25, 2014 (KR) 10-2014-0165153

(51) Int. Cl. F21S 8/10

(52) U.S. Cl. CPC F21S 48/24; F21S 48/215; F21S 48/2212; F21S 48/23

(57) ABSTRACT

A light source module of a lamp for a vehicle includes one LED light source. A PCB substrate controls supply of an electric current to the LED light source. A primary pattern film is layered on the PCB substrate and has a first optic protrusion formed thereon. The first optic protrusion implements a first light emitting image having a specific pattern using light of the LED light source. An optical resin is layered on the primary pattern film, and uniformly transmits the light of the LED light source throughout the entire primary pattern film. A secondary pattern film is layered on the optical resin and has a second optic protrusion formed thereon. The second optic protrusion implements a second light emitting image different from the first light emitting image.

### CROSS REFERENCE TO RELATED APPLICATION

The present application claims the benefit of priority to Korean Patent Application No. 10-2014-0165153, filed on Nov. 25, 2014, the entire contents of which is incorporated herein for all purposes by this reference.

### TECHNICAL FIELD

The present disclosure relates to a light source module of a lamp for a vehicle, and more particularly, to a light source module of a lamp for a vehicle capable of realizing light emitting images having two patterns with one light source as a light source module that constitutes a rear combination lamp.

### BACKGROUND

A rear combination lamp for a vehicle is mounted to a rear portion of the vehicle. The rear combination lamp includes a back lamp that is turned on when reversing, a brake lamp that is turned on when braking, and a turn signal lamp.

There has been a growing tendency to utilize a rear combination lamp using, as a light source, a light emitting diode (LED) that is prolonged in service life and high in light efficiency. As shown in FIG. 1, a light source module 10 of the conventional rear combination lamp includes an LED light source 11, a PCB substrate 12 controlling supply of an electric current to the LED light source 11, a reflection plate 13 reflecting light emitted from the LED light source 11 towards an outer lens 21, and a light diffusion lens 14 provided in front of the reflection plate 13 to diffuse light from the LED light source 11.

However, the conventional light source module 10 is configured such that the reflection plate 13 is provided in front of the LED light source 11. Thus, this is problematic in that a whole size of an optical system including the LED light source 11 and the outer lens 21 is increased, so that the degree of freedom in design is reduced, a weight is increased, and thereby, manufacturing cost thereof is increased.

Further, the conventional light source module 10 converts the light emitted from the LED light source 11 into a simple light emitting image, such as a dot, a line, or a face. Here, visibility is low, so that the number of LED light sources 11 should be increased to improve the visibility, thus incurring high manufacturing cost.

FIGS. 2A to 2C show light emitting images implemented by the conventional light source module 10. FIG. 2A shows a light emitting image 31 in the form of a multi-dot, FIG. 2B shows a light emitting image 31 in the form of a line, and FIG. 2C shows a light emitting image 33 in the form of a face.

Further, the conventional light source module has the following problems: if it has a single light source, it is possible to implement only one kind of pattern image, so that it is impossible to satisfy consumers' desires requiring various designs for the light emitting image. Thus, in order to implement light emitting images having a plurality of patterns, the number of light sources should be increased, so that manufacturing cost as well as a weight is increased and the size of the lamp is inevitably increased.

The foregoing is intended merely to aid in the understanding of the background of the present disclosure, and is not intended to mean that the present disclosure falls within the purview of the related art that is already known to those skilled in the art.

### SUMMARY

The present disclosure has been made keeping in mind the above problems occurring in the related art, and an aspect of the present inventive concept provides a light source module of a lamp for a vehicle, in which light emitting images having two different patterns are implemented by one light source, thus realizing various designs for the light emitting image and improving marketability.

Another aspect of the present inventive concept provides a light source module of a lamp for a vehicle, which is capable of implementing a bezel image by creating a hidden effect due to light concentration and vapor deposition when a light source is turned off, thus providing an improved effect of the lamp.

Yet another aspect of the present inventive concept provides a light source module of a lamp for a vehicle, in which light emitting images of two patterns can be implemented by one light source, thus reducing manufacturing cost as well as weight, in addition to significantly reducing size of the lamp.

Still another aspect of the present inventive concept provides a light source module of a lamp for a vehicle, in which no additional reflector is provided in front of a light source, thus reducing size and weight of an optical system, in addition to achieving cost savings.

According to an exemplary embodiment of the present inventive concept, a light source module of a lamp for a vehicle includes one LED light source. A PCB substrate controls supply of an electric current to the LED light source. A primary pattern film is layered on the PCB substrate and has a first optic protrusion formed thereon. The first optic protrusion implements a first light emitting image having a specific pattern using light of the LED light source. An optical resin is layered on the primary pattern film, and uniformly transmits the light of the LED light source throughout the entire primary pattern film. A secondary pattern film is layered on the optical resin and has a second optic protrusion formed thereon. The second optic protrusion implements a second light emitting image different from the first light emitting image.

The light source module may further include a reflective film interposed between the PCB substrate and the primary pattern film. The reflective film reflects forwards the light of the LED light source that is scattered backwards when the LED light source is turned on. The reflective film realizes a hidden effect of vapor deposition when the LED light source is turned off.

The light source module may further include an air layer formed between the primary pattern film and the reflective film. The air layer increases reflectivity of the light of the LED light source that penetrates through the primary pattern film and increases light efficiency, thus enhancing sharpness of the first light emitting.

The light source module may further include a bezel integrally coupled along an edge of the optical resin, and implementing a bezel image via the vapor deposition along with the reflective film when the LED light source is turned off.

The first optic protrusion and the second optic protrusion may be oriented in different directions from each other, and may protrude in opposite directions.

The primary pattern film may be coupled in such a way that the first optic protrusion protrudes towards the reflective film. The second optic protrusion protrudes towards the outer lens of the lamp, so that the second optic protrusion may be in contact with an air layer between the secondary pattern film and the outer lens.

An angle between an oriented direction of the first optic protrusion and that of the second optic protrusion may be less than 90 degrees to implement a light emitting image formed by overlapping the first light emitting image with the second light emitting image or a light emitting image formed by crossing the first light emitting image and the second light emitting image.

A radiating direction of light output from the LED light source may be perpendicular to the oriented direction of the first optic protrusion and the oriented direction of the second optic protrusion, respectively, to implement a light emitting image formed by overlapping the first light emitting image with the second light emitting image or a light emitting image formed by crossing the first light emitting image and the second light emitting image.

The light source module may be mounted to a lamp housing via a bracket, and the lamp housing may be fixedly mounted to a vehicle body.

The light source module may have a flexible plate shape having a curved surface.

As is apparent from the above description, the light source module of the lamp for the vehicle is advantageous in that the first and second light emitting images having the two different patterns are implemented by the one light source, thus realizing various designs for the light emitting image, and thereby satisfying consumers' desires and improving marketability.

Further, the light source module of the lamp for the vehicle is advantageous in that it is capable of implementing a bezel image by creating the hidden effect due to the vapor deposition by the reflective film and the bezel when the light source is turned off, thus providing the more improved luxurious effect of the lamp.

Furthermore, the light source module of the lamp for the vehicle is advantageous in that the light emitting images of the two patterns can be implemented by the one light source, thus reducing manufacturing cost as well as weight, in addition to significantly reducing size of the lamp.

Further, the light source module of the lamp for the vehicle is advantageous in that no additional reflector is provided in front of the light source, thus reducing the whole size of the optical system including the light source and the lens, and thereby improving the degree of freedom in design and reducing the weight cost.

### BRIEF DESCRIPTION OF THE DRAWINGS

The above and other objects, features and advantages of the present disclosure will be more clearly understood from the following detailed description taken in conjunction with the accompanying drawings.

FIG. 1 is a view illustrating a conventional light source module of a rear combination lamp for a vehicle.

FIGS. 2A to 2C are views showing light emitting images implemented by the conventional light source module.

FIG. 3 is a view illustrating a light source module of a rear combination lamp for a vehicle according to the present disclosure

FIGS. 4 and 5 are views illustrating a primary pattern film and a secondary pattern film according to the present disclosure.

FIG. 6 is a view illustrating a first light emitting image and a second light emitting image implemented by the light source module according to the present disclosure.

FIG. 7 is a view showing an image implemented by the rear combination lamp using the light source module according to the present disclosure.

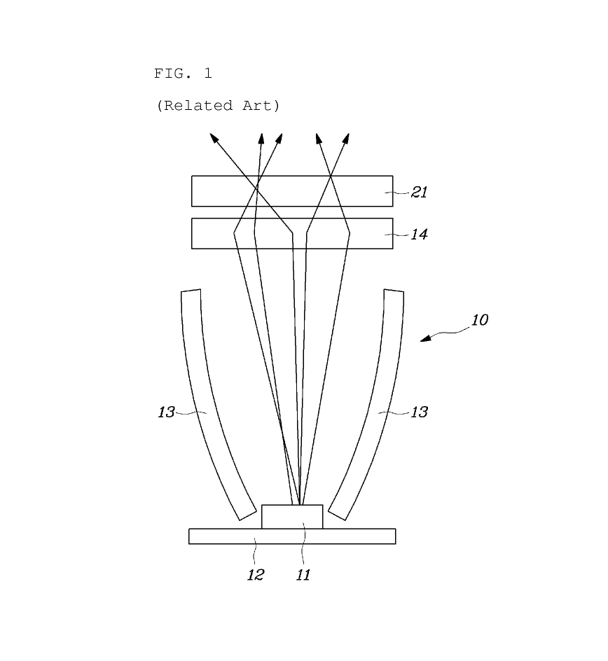

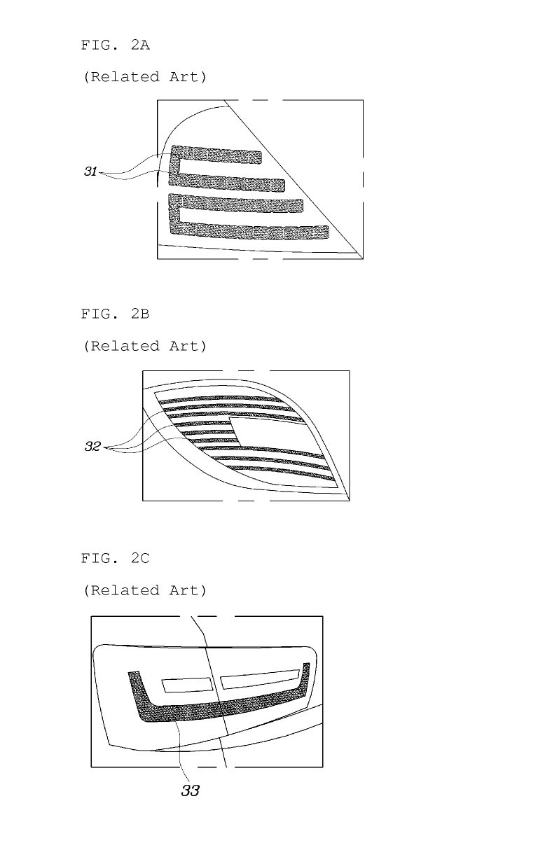

### DETAILED DESCRIPTION

Hereinbelow, a light source module of a lamp for a vehicle according to exemplary embodiment of the present inventive concept will be described with reference to the accompanying drawings.

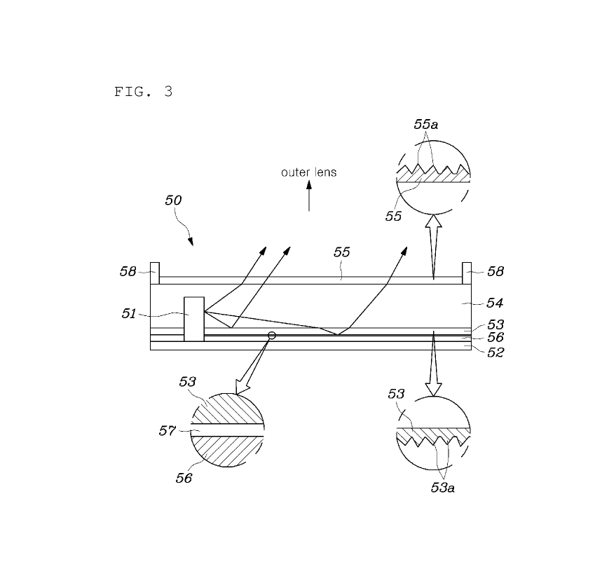

As shown in FIGS. 3 to 7, a light source module 50 of a lamp for a vehicle according to the present disclosure includes one LED light source 51, a PCB substrate 52, a primary pattern film 53, an optical resin 54, and a secondary pattern film 55. The PCB substrate 52 controls the supply of an electric current to the LED light source 51. The primary pattern film 53 is layered on the PCB substrate 52 and has a first optic protrusion 53a formed thereon. The first optic protrusion 53a implements a first light emitting image 61 having a specific pattern using the light of the LED light source 51. The optical resin 54 is layered on the primary pattern film 53 and uniformly transmits the light of the LED light source 51 throughout a whole section of the primary pattern film 53. The secondary pattern film 55 is layered on the optical resin 54 and has a second optic protrusion 55a formed thereon. The second optic protrusion 55a implements a second light emitting image 62 which is different from the first light emitting image 61.

A first end of the LED light source 51 is electrically connected to the PCB substrate 52, while a second end thereof faces to the front at which an outer lens is located. Particularly, the first end is disposed on a side of the first optic protrusion 53a formed on the primary pattern film 53, while the second end is disposed in the optical resin 54.

The optical resin 54 is a medium for transmitting light from the LED light source 51 towards the primary pattern film 53. This allows the light emitted from the LED light source 51 to be induced to the first optic protrusion 53a of the primary pattern film 53, thus improving light efficiency.

The optical resin 54 may use poly methyl methacrylate (PMMA) or ultraviolet-ray (UV) curing resin, without being limited thereto.

The light source module 50 of the present disclosure further includes a reflective film 56 that is interposed between the PCB substrate 52 and the primary pattern film 53. The reflective film 56 reflects forwards the light of the LED light source 51 that is scattered backwards when the LED light source 51 is turned on, and realizes a hidden effect of vapor deposition when the LED light source 51 is turned off.

The reflective film 56 is an aluminum-deposited reflective film for increasing the light reflecting efficiency. When the LED light source 51 is turned on, the reflective film 56 serves to reflect forwards the light of the LED light source 51 that is penetrated through the primary pattern film 53 and is scattered backwards. In contrast, when the LED light source 51 is turned off, the reflective film 56 realizes the hidden effect of vapor deposition, thus providing an improved effect of the lamp.

Most of the light emitted from the LED light source 51 is reflected by the first optic protrusion 53a of the primary pattern film 53 to be output to the outer lens which is disposed at a front side of the lamp. However, some of the light may not be reflected by the first optic protrusion 53a but may be scattered to a rear position at which the PCB substrate 52 is located. Thus, the reflective film 56 according to the present invention serves to reflect the light of the LED light source 51, which is scattered backwards, towards the first optic protrusion 53a of the primary pattern film 53 again.

That is, the reflective film 56 according to the present disclosure serves to reflect the light of the LED light source 51, scattered to the rear position at which the PCB substrate 52 is located, towards the first optic protrusion 53a of the primary pattern film 53 again, thus considerably reducing an optical loss due to the scattering of the light, additionally obtaining the quantity of light, and thereby significantly improving the light efficiency of the lamp.

Further, the reflective film 55 realizes the hidden effect of the vapor deposition when the LED light source 51 is turned off, thus aiding in providing the luxurious effect of the lamp.

The light source module 50 according to the present disclosure has a flexible plate shape bent in a curved surface. Here, the secondary pattern film 55 serves to protect the optical resin 54 and to maintain the shape of the optical resin 54 that is bent in the curved surface.

Further, the light source module 50 according to the present disclosure further includes an air layer 57 that is formed between the primary pattern film 53 and the reflective film 56. The air layer 57 increases the reflectivity of the light of the LED light source 51 that has penetrated through the primary pattern film 53, thereby increasing light efficiency and enhancing the sharpness of the first light emitting image 61.

The light source module 50 according to the present disclosure may further include a bezel 58 that is integrally coupled along an edge of the optical resin 54. The bezel 58 creates a bezel image via vapor deposition along with the reflective film 56 when the LED light source 51 is turned off.

The bezel 58 creates a bezel image 64 by the vapor deposition along with the reflective film 56 along the edge of the lamp when the LED light source 51 is turned off, thus providing the more improved luxurious effect of the lamp.

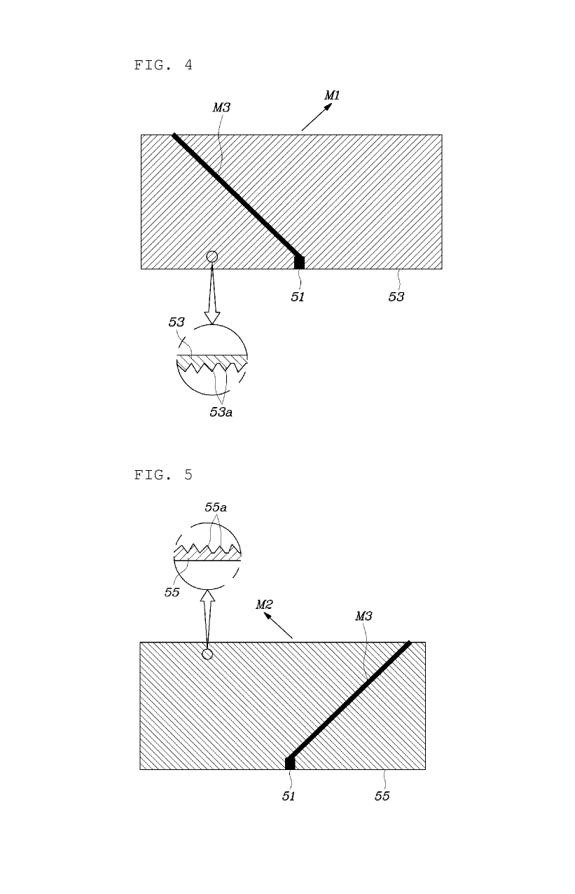

According to the present disclosure, an oriented direction M1 of the first optic protrusion 53a is different from an oriented direction M2 of the second optic protrusion 55a as shown in FIGS. 4 and 5. Further, the protruding directions of the optic protrusions 53a and 55a are opposite to each other. This can implement two different kinds of first and second light emitting images 61 and 62 using one LED light source 51 with the primary pattern film 53 and the secondary pattern film 55 stacked on each other.

To be more specific, the primary pattern film 53 is coupled in such a way that the first optic protrusion 53a protrudes towards the reflective film 56. The secondary pattern film 55 is coupled in such a way that the second optic protrusion 55a protrudes towards the outer lens of the lamp, so that the second optic protrusion 55a is in contact with the air layer between the secondary pattern film 56 and the outer lens.

As the second optic protrusion 55a is also in contact with the air layer, the light of the LED light source 51 that has penetrated through the secondary pattern film 55 increases the light efficiency, and thereby the sharpness of the second light emitting image 62 is also improved significantly.

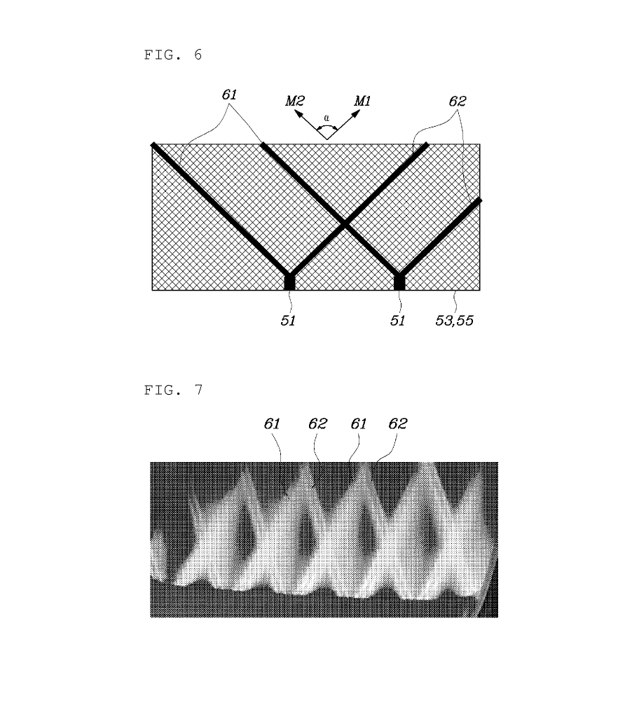

In order to implement a light emitting image formed by overlapping the first light emitting image 61 with the second light emitting image 62 or a light emitting image formed by crossing the first light emitting image 61 and the second light emitting image 62 as shown in FIGS. 6 and 7, an angle α between the oriented direction M1 of the first optic protrusion 53a and the oriented direction M2 of the second optic protrusion 55a may be less than 90 degrees. Further, a radiating direction M3 of light output from the LED light source 51 is perpendicular to the oriented direction M1 of the first optic protrusion 53a and the oriented direction M2 of the second optic protrusion 55a, respectively.

The light source module 50 according to the present disclosure configured as described above is mounted to a lamp housing via a bracket, and the lamp housing is fixedly mounted to a vehicle body.

As described above, the present disclosure provides a light source module of a lamp for a vehicle, in which first and second light emitting images having two different kinds of patterns are implemented by one light source, thus realizing various designs for a light emitting image and thereby satisfying consumers' desires and improving marketability.

Further, the present disclosure provides a light source module of a lamp for a vehicle, in which it is capable of implementing a bezel image by creating a hidden effect due to vapor deposition by a reflective film and a bezel when a light source is turned off, thus providing a more improved luxurious effect of the lamp.

Furthermore, the present disclosure provides a light source module of a lamp for a vehicle, in which light emitting images of two patterns can be implemented by one light source, thus reducing manufacturing cost as well as a weight, in addition to significantly reducing the size of the lamp.

Further, the present disclosure provides a light source module of a lamp for a vehicle, which is configured such that no additional reflector is provided in front of a light source, thus reducing the whole size of an optical system including the light source and a lens, and thereby improving the degree of freedom in design, reducing a weight, and in addition, achieving cost savings.

Although exemplary embodiments of the present inventive concept have been disclosed for illustrative purposes, those skilled in the art will appreciate that various modifications, additions and substitutions are possible, without departing from the scope and spirit of the disclosure as disclosed in the accompanying claims.

What is claimed is:

1. A light source module of a lamp for a vehicle, comprising:
one LED light source;
a PCB substrate controlling supply of an electric current to the LED light source;
a primary pattern film layered on the PCB substrate and having a first optic protrusion formed thereon, the first optic protrusion implementing a first light emitting image having a specific pattern using light of the LED light source;
an optical resin layered on the primary pattern film, and uniformly transmitting the light of the LED light source throughout the entire primary pattern film; and
a secondary pattern film layered on the optical resin and having a second optic protrusion formed thereon, the second optic protrusion implementing a second light emitting image different from the first light emitting image.

2. The light source module as set forth in claim 1, further comprising:
a reflective film interposed between the PCB substrate and the primary pattern film, the reflective film reflecting forwards the light of the LED light source that is scattered backwards when the LED light source is turned on, the reflective film realizing a hidden effect of vapor deposition when the LED light source is turned off.

3. The light source module as set forth in claim 2, further comprising:
an air layer formed between the primary pattern film and the reflective film, the air layer increasing reflectivity of the light of the LED light source that penetrates through the primary pattern film and increasing light efficiency, thus enhancing sharpness of the first light emitting.

4. The light source module as set forth in claim 2, further comprising:
a bezel integrally coupled along an edge of the optical resin, and implementing a bezel image via the vapor deposition along with the reflective film when the LED light source is turned off.

5. The light source module as set forth in claim 2, wherein the first optic protrusion and the second optic protrusion are oriented in different directions from each other, and protrude in opposite directions.

6. The light source module as set forth in claim 5, wherein the primary pattern film is coupled in such a way that the first optic protrusion protrudes towards the reflective film, and
the second optic protrusion protrudes towards an outer lens of the lamp, so that the second optic protrusion is in contact with an air layer between the secondary pattern film and the outer lens.

7. The light source module as set forth in claim 5, wherein an angle between an oriented direction of the first optic protrusion and that of the second optic protrusion is less than 90 degrees to implement a light emitting image formed by overlapping the first light emitting image with the second light emitting image or a light emitting image formed by crossing the first light emitting image and the second light emitting image.

8. The light source module as set forth in claim 5, wherein a radiating direction of the light output from the LED light source is perpendicular to an oriented direction of the first optic protrusion and the oriented direction of the second optic protrusion, respectively, to implement a light emitting image formed by overlapping the first light emitting image with the second light emitting image or a light emitting image formed by crossing the first light emitting image and the second light emitting image.

9. The light source module as set forth in claim 1, wherein the light source module is mounted to a lamp housing via a bracket, and
the lamp housing is fixedly mounted to a vehicle body.

10. The light source module as set forth in claim 1, wherein the light source module has a flexible plate shape and is bent in a curved surface.

11. The light source module as set forth in claim 6, wherein the outer lens is disposed at a front side of the lamp.
